(19) United States
(12) Patent Application Publication
(10) Pub. No.: US 2018/0086257 A1
(43) Pub. Date: Mar. 29, 2018

(54) VARIABLE INTERIOR LIGHTING DEVICE FOR A VEHICLE

(71) Applicant: VALEO VISION, Bobigny Cedex (FR)

(72) Inventors: Jerome LECORRE, Bobigny Cedex (FR); Pierre ALBOU, Bobigny Cedex (FR); Pierre-Louis TASSY, Bobigny Cedex (FR); Birane GAYE, Bobigny Cedex (FR)

(73) Assignee: VALEO VISION, Bobigny Cedex (FR)

(21) Appl. No.: 15/718,716

(22) Filed: Sep. 28, 2017

(30) Foreign Application Priority Data
Sep. 28, 2016 (FR) 16 59248

(51) Int. Cl. B60Q 3/60; F21V 5/04; F21V 5/08; G02B 3/14; G02B 26/00

(52) U.S. Cl. CPC B60Q 3/60; F21V 5/045; G02B 26/005; G02B 3/14; G02B 26/004; F21V 5/08

(57) ABSTRACT

The invention concerns an interior lighting device for a vehicle, in particular a motor vehicle, comprising at least one light source; an optical projection device suitable for being supplied with light by the light source or sources and for forming a light beam that has variable geometry. The optical projection device is configured to have a variable focal distance.

The invention concerns the field of lighting, and in particular of interior lighting, particularly for motor vehicles.

Published patent document EP 2 676 843 A1 discloses an individual lighting device for a vehicle seat. The device comprises several light sources, each emitting in a preferred direction. The lighting produced by this device can be adjusted by varying the brightness of the light sources. This device has the advantage of being simple and economical to construct. However, it offers only rough adjustment in that it is limited to the geometry of the various beams, which is fixed.

The aim of the invention is to overcome at least one disadvantage of the abovementioned prior art. More specifically, the aim of the invention is to propose a lighting device that allows the light beam to be adjusted more finely, in a simple and reliable manner.

The invention concerns an interior lighting device for a vehicle, in particular a motor vehicle, comprising: at least one light source; an optical projection device suitable for being supplied with light by the light source or sources and for forming a light beam that has variable geometry; remarkable in that the optical projection device is configured to have a variable focal distance.

Optical devices that have a variable focal distance generally have at least one optical surface with variable geometry. Technological advancements are bringing us closer to the development of variable focus lenses without variable geometry. For example, an electric field (standing wave) or a liquid crystal spatial phase modulator can create a variable gradient index lens with constant geometry.

“Optical surface with variable geometry” refers to the fact that the shape and/or orientation of the surface in question is variable.

According to an advantageous embodiment of the invention, the or at least one of the optical surfaces with variable geometry is a surface, preferably an output surface, of a lens, said surface having a variable radius of curvature.

According to an advantageous embodiment of the invention, the lens comprises a transparent liquid optical material in a chamber.

According to an advantageous embodiment of the invention, the lens comprises an elastically deformable wall in contact with the transparent liquid optical material, the radius of curvature of said wall being variable by movement of said material relative to the chamber.

According to an advantageous embodiment of the invention, the transparent liquid optical material is moved by applying a magnetic field.

The transparent liquid material can, in particular, be a material made from polymer, water, oil, liquid crystals and/or silicone.

According to an advantageous embodiment of the invention, the lens comprises a chamber enclosing two different transparent liquid optical materials in direct contact with each other so as to form a diopter, the chamber comprising a hydrophobic side wall in contact with the two materials, and electrodes configured to allow an electric field to be applied between one of said materials and said wall with a view to modifying the wetting of said wall and said material, the modification of said wetting modifying the radius of curvature of the diopter.

Advantageously, the two different transparent liquid optical materials are respectively water and oil.

According to an advantageous embodiment of the invention, varying the curvature of the surface of the lens makes it possible to vary the angular field of the light beam.

According to an advantageous embodiment of the invention, the lens is configured and arranged in such a way that varying the geometry, preferably the curvature, of the surface of said lens, makes it possible to vary the orientation of the light beam.

Advantageously, the optical projection device comprises a shaping lens arranged between the light source or sources and the lens with at least one optical surface with variable geometry, said shaping lens being configured to form a light beam, preferably a convergent light beam, from the light produced by the light source or sources.

According to an advantageous embodiment of the invention, the or at least one of the optical surfaces with variable geometry comprises a microsystem with at least one micro-mirror, the orientation of which is actuated electrically.

According to an advantageous embodiment of the invention, the optical projection device further comprises an optical element, such as a biconvex lens, capable of focusing the light emitted by the light source or sources towards the micro-mirror or mirrors.

According to an advantageous embodiment of the invention, the optical projection device further comprises a projection lens capable of receiving the light reflected by the micro-mirror or mirrors and of forming the light beam.

According to an advantageous embodiment of the invention, actuating the orientation of the micro-mirror or mirrors makes it possible to vary the orientation of the light beam.

According to an advantageous embodiment of the invention, the device comprises the microsystem with the micro-mirror or mirrors and the lens with the surface that has a variable radius of curvature, said lens being arranged in such a way as to receive the light reflected by the micro-mirror or mirrors.

According to an advantageous embodiment of the invention, the optical projection device, and advantageously the optical surface or surfaces with variable geometry, can be actuated electrically in such a way as to vary the focal distance, the orientation of the light beam and/or the beam angle being adjustable via an electric control signal.

The measures of the invention are advantageous in that they give the lighting device the ability to adapt the beam angle and/or the orientation of the light beam, in particular depending on the needs of the people concerned. This adaptation is achieved by means of an electrical control, without needing a potentially bulky external electromechanical device that could malfunction. Indeed, the variation in curvature of an input or output surface of a lens takes place inside a closed and compact enclosure. Similarly, the micro-mirror or mirrors of a microsystem are pivoted inside the system and as a primary function of said system. The level of integration of the solution of the invention, i.e. the fact that the geometry of at least one optical surface is varied inside the lighting device, is high, and thus makes the device compact, simple and reliable.

Other features and advantages of the present invention will be better understood in the light of the description and the drawings, in which:

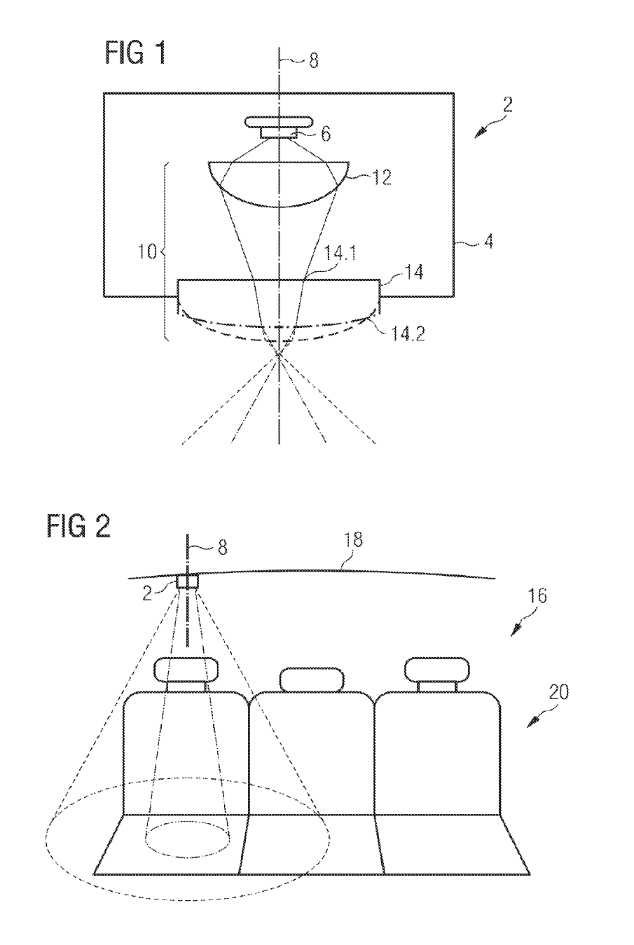

FIG. 1 is a schematic illustration of a lighting device, according to a first embodiment of the invention;

FIG. 2 shows the variation in the light beam of the device of FIG. 1 arranged above a row of seats in a vehicle;

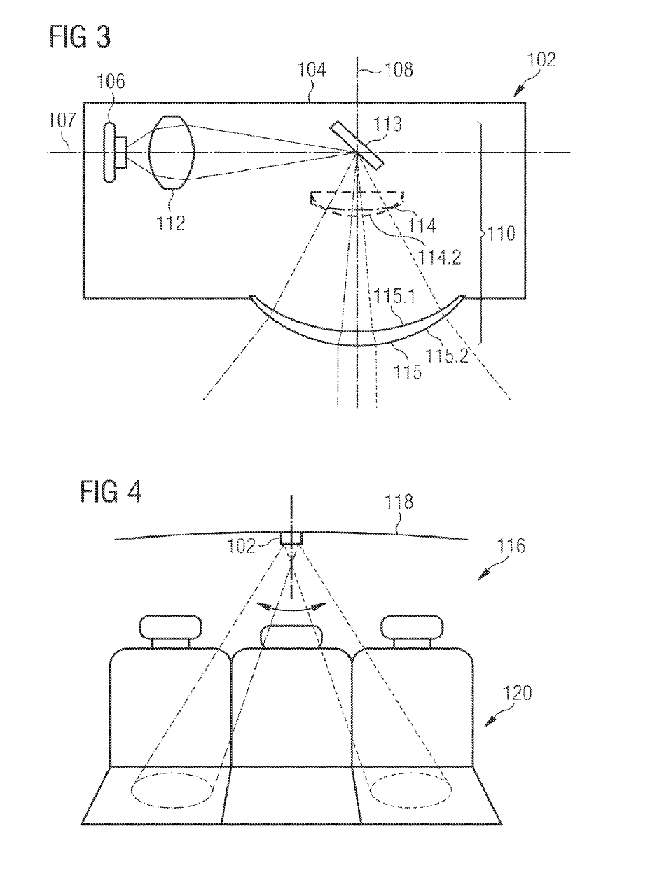

FIG. 3 is a schematic illustration of a lighting device, according to a second embodiment of the invention;

FIG. 4 shows the variation in the light beam of the device of FIG. 3 arranged above a row of seats in a vehicle;

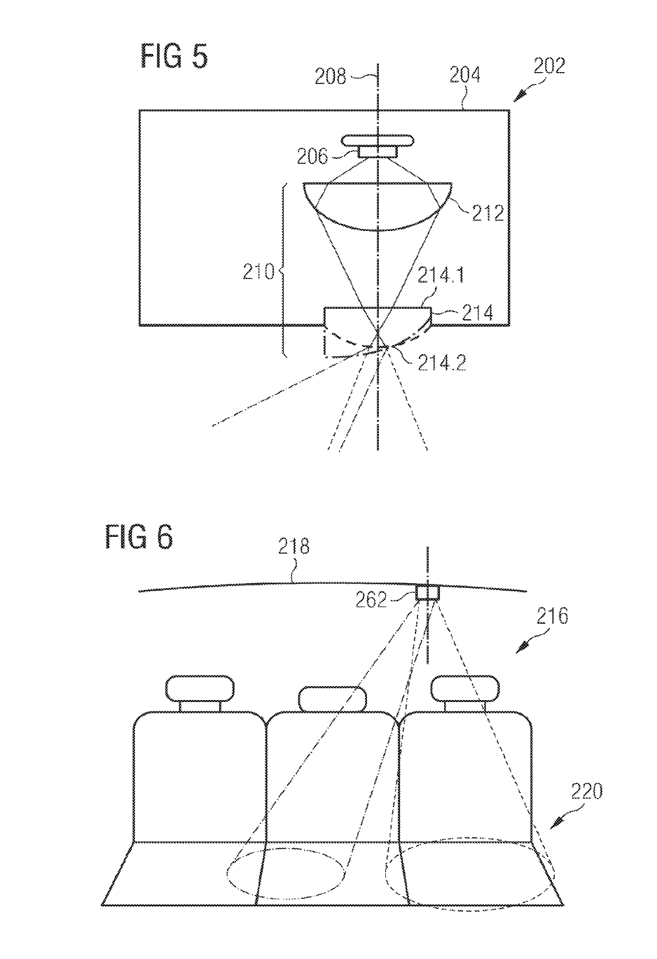

FIG. 5 is a schematic illustration of a lighting device, according to a third embodiment of the invention;

FIG. 6 shows the variation in the light beam of the device of FIG. 5 arranged above a row of seats in a vehicle.

FIGS. 1 and 2 show an interior lighting device according to a first embodiment. FIG. 1 is a schematic illustration of the device, and FIG. 2 shows the device installed inside a vehicle and the variation of the light beam.

In FIG. 1, the lighting device 2 comprises a housing 4 accommodating one or more light sources 6. In this case, a single light-emitting diode light source is shown, it nevertheless being understood that other types of light source, in particular incandescent light sources, can be envisaged. The light source 6 essentially illuminates a half-space delimited by the plane of its support, along the optical axis 8 of the device 2. The latter also comprises an optical projection device 10 capable of receiving the light emitted by the light source 6 and of forming an illumination beam. The optical device 10 can comprise a first shaping lens 12 for shaping the beam produced by the light source 6. This lens 12 is advantageously a convex lens. It allows the rays emitted by the light source 6 into the half-space to be deflected into a divergent beam with a smaller beam angle.

The optical device 10 comprises a second lens 14 with variable geometry. More specifically, at least one of the input surface 14.1 and the output surface 14.2 has variable curvature. In the example in FIG. 1, the output surface 14.2 has variable curvature. The variation in curvature is shown schematically by a first dashed line profile, said profile being generally straight, and a second dash-dotted line profile (in the style of an axis line), said profile being domed so as to form a convex surface.

The beam produced when the lens 14 is in the configuration in which its output surface 14.2 is generally flat is shown by the dashed line. It should be noted that this flat configuration is no more than an example, it being understood that it could be a curved configuration. Similarly, the beam produced when the lens 14 is configured such that its output surface 14.2 is convex is shown by the dash-dotted line. It can be seen that the flat configuration of the output surface 14.2 produces a wider beam than the convex configuration of said face.

The lens can comprise a main optical material that is liquid and is delimited by an elastically deformable wall. In the configuration of the lens 14 in FIG. 1, the elastically deformable wall corresponds to the output surface 14.2. The liquid optical material is contained in a chamber of the lens. The curvature of the output surface formed by the deformable wall can be varied by moving a portion of the liquid optical material out of or into the chamber. This movement can be made, in particular, by an electromagnetic actuator acting on a portion of the elastic wall of the chamber. Such lenses are commercially available, for example from the Optotune® company.

The lens can also comprise two different liquid optical materials in contact with each other, forming a diopter. One of the materials can be water, and the other oil. These materials are contained in a chamber of which one side wall, at one of the two materials, comprises a hydrophobic coating in contact with said material. This portion of wall forms a first electrode, while a second electrode is in contact with the liquid optical material in contact with the wall forming the first electrode. When electrical voltage is applied to the electrodes, an electric field is generated in the liquid material where it is in contact with the hydrophobic coating. This electric field modifies the wetting of the coating in question by the material, according to the electrowetting principle, which is well known per se. Varying the wetting in this way modifies the meniscus formed by the material in contact with the wall in question and the other material. This modification results in a change in curvature of the diopter between the two materials. Such lenses are commercially available from the Varioptic® company.

FIG. 2 shows the lighting device 2 of FIG. 1 installed in a vehicle 16, more specifically in the roof ceiling 18 above a row of seats 20, such as, for example, a row of rear seats. In the example in FIG. 2, the lighting device is arranged above the right-hand seat (to the left in the figure). It can be seen that varying the focus of the beam makes it possible to shift from a general diffuse lighting mode, in which the beam is wide (shown by the dashed lines), to a more concentrated lighting mode, in particular intended for reading, in which the beam narrows (shown by the dash-dotted lines). While the light power at the light source or sources remains constant, varying the width of the beam thus makes it possible to shift from a wide light beam providing moderate illumination to a narrow light beam providing brighter illumination.

FIGS. 3 and 4 show an interior lighting device according to a second embodiment. FIG. 3 is a schematic illustration of the device, and FIG. 4 shows the device installed inside a vehicle and the variation of the light beam. The reference numbers of the first embodiment are used to denote the identical or corresponding elements in the second embodiment, the latter numbers albeit being increased by 100. Moreover, reference is made to the description of these elements in relation with FIGS. 1 and 2. Specific reference numbers between 100 and 200 are used to denote the specific elements.

The lighting device 102 comprises a housing 104 accommodating a light source and an optical projection device 110. The light source 106 is arranged to illuminate along a first optical axis 107 transverse to a second optical axis 108 that corresponds to the output optical axis of the device. The first optical axis 107 can form, with the second optical axis 108, an angle of between 60° and 90°, and preferably between 70° and 90°. The optical projection device 110 comprises a first lens 112 arranged on the first optical axis 107. This lens 112 is a convex lens in order to focus the light emitted by the light source 106 towards an electromechanical microsystem 113 comprising a micro-mirror or an array of micro-mirrors. Such microsystems are commonly referred to by the acronym DMD, which stands for Digital Micro System. These electromechanical microsystems allow a digital image to be projected by reflection on micro-mirrors that can tilt between two different positions. The inclination of each of these positions, relative to a reference direction corresponding to the second optical axis 108, can be between 10° and 15°. The scanning angle can therefore be between 20° and 30°. More generally, the system can be a Micro-Opto-Electro-Mechanical System or MOEMS, which is a subassembly of a Micro-Electro-Mechanical System or MEMS. MOEMS are capable of sensing or handling optical signals at a smaller scale, using integrated mechanical or electrical systems.

The optical projection device 110 comprises a second lens 115 arranged along the second optical axis 108, so as to receive the light reflected by the microsystem 113. This lens 115 is advantageously a projection lens for widening the beam originating from the microsystem 113. The output surface 115.2 of the lens 115 is advantageously curved and convex.

Depending on the angular position of the micro-mirror or mirrors in the microsystem 113, the light beam will be oriented to one side or the other of the second optical axis 108, as shown in by the dashed lines and dash-dotted lines (axis lines) in FIG. 3.

The shift from one position to another can be made in a binary manner or continuously with the possibility of choosing one or more intermediate positions. In this case, the microsystem needs to be designed to allow the micro-mirror or mirrors to occupy such angular positions.

Referring still to FIG. 3, the optical projection device 110 can comprise a variable focus lens 114, similar to the lens 14 of the first embodiment (FIG. 1), i.e. at least one of the input surface and the output surface of the lens having variable curvature. Such a lens makes it possible to vary the beam angle of the light beam, while the microsystem 113 makes it possible to move the beam by varying its orientation. When the microsystem is designed to be binary, i.e. to have two stable orientations of the micro-mirror or mirrors, it is also possible to envisage the optical projection device 110 comprising two variable focus lenses arranged, respectively, perpendicular to the optical axes (not shown) of the two beams. It should also be noted that a projection lens 115 with variable focus can be envisaged, similar to the lens 14 of the first embodiment (FIG. 1).

FIG. 4 shows the lighting device 102 of FIG. 3 installed in a vehicle 116, more specifically in the roof ceiling 118 above a row of seats 120, such as, for example, a row of rear seats. In the example in FIG. 4, the lighting device is arranged above the central seat and selectively illuminates the left-hand seat or the right-hand seat. However, it should be noted that the lighting device can be arranged differently with respect to the seats.

FIGS. 5 and 6 show an interior lighting device according to a third embodiment. FIG. 5 is a schematic illustration of the device, and FIG. 6 shows the device installed inside a vehicle and the variation of the light beam. The reference numbers of the first embodiment are used to denote the identical or corresponding elements in the third embodiment, the latter numbers albeit being increased by 200. Moreover, reference is made to the description of these elements in relation with FIGS. 1 and 2. Reference numbers between 200 and 300 and different from the others are used to denote the specific elements.

In reference to FIG. 5, the lighting device 202 comprises a housing 204 accommodating a light source 206 configured to illuminate along an optical axis 208. The lighting device 202 comprises an optical projection device 210. This can comprise a first lens 212, similar to the lens 12 of the first embodiment (FIG. 1). This is a shaping lens for shaping the beam produced by the light source 206. This lens 212 is advantageously a convex lens.

The optical device 210 comprises a second lens 214 with variable geometry, similar to the lens 14 of the first embodiment (FIG. 1). More specifically, at least one of the input surface 214.1 and the output surface 214.2 has variable curvature. In the example in FIG. 5, the output surface 214.2 has variable curvature. The variation in curvature is shown schematically by a first dashed line profile, said profile being generally domed and symmetrical relative to the optical axis 208, and a second dash-dotted line profile (in the style of an axis line), said profile being domed in an asymmetrical manner. As shown in FIG. 5, the asymmetrical profile allows the light rays to be deflected so as to form a beam that is inclined relative to the optical axis 208. In other words, the dissymmetrical curvature of one of the input surface and output surface of the lens 214, in this case the output surface, makes it possible to modify the orientation of the beam.

FIG. 6 shows the lighting device 202 of FIG. 5 installed in a vehicle 216, more specifically in the roof ceiling 218 above a row of seats 220, such as, for example, a row of rear seats. In the example in FIG. 6, the lighting device is arranged above the left-hand seat (to the right in the figure). It can be seen that varying the curvature of the output surface of the lens of the lighting device makes it possible to change the orientation of the light beam, in this case shifting it towards the central seat.

Generally, the lighting devices according to the invention make it possible to adjust the beam angle and/or the orientation of the light beam produced. They can therefore be arranged on a vehicle roof ceiling, alone or in combination, in order to be able to provide adaptive lighting for the occupants of the vehicle.

In the case of a lighting device in which the orientation of the light beam can be adjusted, it is moreover possible for said orientation to be controlled manually or indeed automatically depending on the movement of a mobile target to be illuminated, in particular a book, for example. In the case of manual control, control buttons can be used, in particular in the form of a “joystick”. In the case of automatic control, one or more cameras can be implemented, with image processing software configured to recognize one or more types of objects, such as a book or an electronic reader.

1. Interior lighting device for a vehicle, in particular a motor vehicle, comprising:
at least one light source;
an optical projection device suitable for being supplied with light by the light source or sources and for forming a light beam that has variable geometry;
wherein the optical projection device is configured to have a variable focal distance.

2. Device according to claim 1, wherein the optical projection device comprises at least one optical surface with variable geometry.

3. Device according to claim 2, wherein the or at least one of the optical surfaces with variable geometry is a surface, preferably an output surface, of a lens, said surface having a variable radius of curvature.

4. Device according to claim 3, wherein the lens comprises a transparent liquid optical material in a chamber.

5. Device according to claim 4, wherein the lens comprises an elastically deformable wall in contact with the transparent liquid optical material, the radius of curvature of said wall being variable by movement of said material relative to the chamber.

6. Device according to claim 5, wherein the transparent liquid optical material is moved by applying a magnetic field.

7. Device according to claim 3, wherein the lens comprises a chamber enclosing two different transparent liquid optical materials in direct contact with each other so as to form a diopter, the chamber comprising a hydrophobic side wall in contact with the two materials, and electrodes configured to allow an electric field to be applied between one of said materials and said wall with a view to modifying the wetting of said wall and said material, the modification of said wetting modifying the radius of curvature of the diopter.

8. Device according to claim 3, wherein varying the curvature of the surface of the lens makes it possible to vary the angular field of the light beam.

9. Device according to claim 3, wherein the lens is configured and arranged in such a way that varying the geometry of the surface of said lens makes it possible to vary the orientation of the light beam.

10. Device according to claim 2, wherein the or at least one of the optical surfaces with variable geometry comprises a microsystem with at least one micro-mirror, the orientation of which is actuated electrically.

11. Device according to claim 10, wherein the optical projection device further comprises an optical element, such as a convex lens, capable of focusing the light emitted by the light source or sources towards the micro-mirror or mirrors.

12. Device according to claim 11, wherein the optical projection device further comprises a projection lens capable of receiving the light reflected by the micro-mirror or mirrors and of forming the light beam.

13. Device according to claim 10, wherein actuating the orientation of the micro-mirror or mirrors makes it possible to vary the orientation of the light beam.

14. Device according to claim 3, wherein the lens with the surface that has a variable radius of curvature is arranged in such a way as to receive the light reflected by the micro-mirror or mirrors.

15. Device according to claim 2, wherein the optical projection device can be actuated electrically in such a way as to vary the focal distance, the orientation and/or the beam angle of the light beam being adjustable via an electric control signal.

16. Device according to claim 4, wherein varying the curvature of the surface of the lens makes it possible to vary the angular field of the light beam

17. Device according to claim 4, wherein the lens is configured and arranged in such a way that varying the geometry of the surface of said lens makes it possible to vary the orientation of the light beam.

18. Device according to claim 3, wherein the or at least one of the optical surfaces with variable geometry comprises a microsystem with at least one micro-mirror, the orientation of which is actuated electrically.

19. Device according to claim 11, wherein actuating the orientation of the micro-mirror or mirrors makes it possible to vary the orientation of the light beam.

20. Device according to claim 4, wherein the lens with the surface that has a variable radius of curvature is arranged in such a way as to receive the light reflected by the micro-mirror or mirrors.
